(19) United States
(12) Patent Application Publication
(10) Pub. No.: US 2026/0112272 A1
(43) Pub. Date: Apr. 23, 2026

(54) DRIVING ASSISTANCE DEVICE AND METHOD FOR IDENTIFYING PEDESTRIAN IN CROSSWALK

(71) Applicants: Hyundai Motor Company, Seoul (KR); Kia Corporation, Seoul (KR)

(72) Inventor: Sung Woo Park, Hwaseong (KR)

(21) Appl. No.: 19/225,422

(22) Filed: Jun. 2, 2025

(30) Foreign Application Priority Data
Oct. 21, 2024 (KR) 10-2024-0144382

(51) Int. Cl. G08G 1/16; B60T 7/12; G08G 1/0967

(52) U.S. Cl. CPC G08G 1/166; B60T 7/12; G08G 1/096783

(57) ABSTRACT

A driving assistance device provided in a vehicle includes a communication device that receives crosswalk-related traffic information by performing V2X (Vehicle to Everything) communication with a signal controller, and a controller that identifies whether a pedestrian is present in a crosswalk based on the crosswalk-related traffic information, and when the pedestrian is present in the crosswalk, determines a time point at which to provide the crosswalk-related traffic information to a driver based on driving information of a vehicle and driver age information, and provides the crosswalk-related traffic information to the driver at the determined time point.

### CROSS-REFERENCE TO RELATED APPLICATION

This application claims under 35 U.S.C. § 119(a) the benefit of Korean Patent Application No. 10-2024-0144382, filed in the Korean Intellectual Property Office on Oct. 21, 2024, the entire contents of which are incorporated herein by reference.

### BACKGROUND

### (a) Technical Field

The present disclosure relates to a driving assistance device and method for providing traffic information based on V2X communication to a vehicle, more particularly, to the driving assistance device and method for identifying a pedestrian that is present in a crosswalk and alerting a driver as to the presence of the pedestrian.

### (b) Description of the Related Art

With the development of automotive technology, the importance of in-vehicle information systems has increased significantly. In particular, navigation systems are playing a pivotal role in integrating various functions beyond simple path guidance. Modern navigation systems provide real-time traffic information, information on nearby facilities, weather information, and more, and provide comprehensive driving environment information to a driver in conjunction with the vehicle's various sensors. However, this increase in information creates a new risk of driver distraction.

One of the most dangerous sections in the road traffic environment is crosswalks, e.g., crosswalks that are located around off-ramps and ramps. The section is characterized by large changes in vehicle speed and frequent interactions with crosswalks. The irregularity of the signal changes makes it difficult for drivers to predict especially when pedestrian-sensitive traffic lights are installed. This increases the perception load on the driver and reduces the reaction time to unexpected situations. Therefore, the risk of accidents in the section is relatively high compared to other sections.

The driver's human characteristics, especially age, are a major factor in driving safety. Older drivers have relatively slower perception and reaction times and are less able to process information in complex road environments. However, current vehicle information systems do not take these individual differences into account and provide one-size-fits-all information.

Advances in vehicle to everything (V2X) communication technology offer new possibilities for improving vehicle safety. This technology enables real-time information exchange between vehicles and vehicles (V2V), vehicles and infrastructure (V2I), and vehicles and pedestrians (V2P). Through the implementation of C-ITS (Cooperative Intelligent Transport Systems), all elements on the road are interconnected and able to share information. This enables the real-time provision of critical information to drivers, such as accidents ahead, construction zones, and the approach of emergency vehicles. However, despite these technological advancements, there is still a lack of consideration regarding the amount and timing of the information provided, as well as tailored information delivery methods that take into account the characteristics of individual drivers. As a result, the full potential of V2X technology has not been fully utilized, particularly in improving safety at crosswalks, e.g., crosswalks located around off-ramps and ramps.

### SUMMARY

An aspect of the present disclosure provides a driving assistance device and method capable of differently determining a time point for providing crosswalk-related traffic information to a driver, e.g., depending on the driver's age.

An aspect of the present disclosure provides a driving assistance system capable of providing crosswalk-related traffic information to a driver at different time points depending on the driver's age.

The technical problems to be solved by the present disclosure are not limited to the aforementioned problems, and any other technical problems not mentioned herein will be clearly understood from the following description by those skilled in the art to which the present disclosure pertains.

According to the present disclosure, a driving assistance device provided in a vehicle includes at least: a communication device configured to receive crosswalk-related traffic information by performing V2X (Vehicle to Everything) communication with a signal controller; and a controller configured to: identify whether a pedestrian is present in a crosswalk based on the crosswalk-related traffic information, based on identifying that the pedestrian is present in the crosswalk, determine a time point at which to provide the crosswalk-related traffic information to a driver of the vehicle based on driving information of the vehicle and driver age information, and provide the crosswalk-related traffic information to the driver at the determined time point.

According to an aspect of the present disclosure, a driving assistance device includes a communication device that receives crosswalk-related traffic information by performing V2X (Vehicle to Everything) communication with a signal controller, and a controller that identifies whether a pedestrian is present in a crosswalk based on the crosswalk-related traffic information, and when the pedestrian is present in the crosswalk, determines a time point at which to provide the crosswalk-related traffic information to a driver based on driving information of a vehicle and driver age information, and provides the crosswalk-related traffic information to the driver at the determined time point.

In an embodiment, the controller may determine a perception-reaction time of the driver based on the driver age information, determine a stopping sight distance of the vehicle based on the perception-reaction time of the driver and the driving information, and determine the time point at which to provide the crosswalk-related traffic information to the driver based on the stopping sight distance.

In an embodiment, the controller may determine the stopping sight distance of the vehicle in further consideration of weather information.

In an embodiment, the crosswalk-related traffic information may include presence or absence of pedestrians, vehicle signal change information, and vehicle stop signal remaining time information.

In an embodiment, the controller may advance the time point as the driver's age increases based on preset perception-reaction times by age group.

In an embodiment, the controller may continuously monitor the driving information of the vehicle after providing the crosswalk-related traffic information to the driver at the time point.

In an embodiment, the controller may predict whether the vehicle is about to violate a vehicle stop signal based on the driving information of the vehicle.

In an embodiment, the controller may control the communication device to perform V2P (Vehicle to Pedestrian) communication with a pedestrian terminal of the pedestrian to provide a warning signal to the pedestrian terminal when the vehicle is predicted to violate the vehicle stop signal.

In an embodiment, the controller may provide an emergency warning signal to the driver when the vehicle is predicted to violate the vehicle stop signal.

In an embodiment, the controller may perform emergency braking when it is identified that braking control of the vehicle is not performed based on the driving information after providing the emergency warning signal to the driver.

According to the present disclosure, a vehicle may include a driving assistance device.

According to the present disclosure, a driving assistance method for assisting a driver of a vehicle, the driving assistance method comprising: receiving, by a communication device of the vehicle, crosswalk-related traffic information by performing V2X (Vehicle to Everything) communication with a signal controller; identifying, by a controller, whether a pedestrian is present in a crosswalk based on the crosswalk-related traffic information; determining, by the controller, based on identifying that the pedestrian is present in the crosswalk, a time point at which to provide the crosswalk-related traffic information to a driver based on driving information of a vehicle and driver age information; and providing the crosswalk-related traffic information to the driver at the determined time point.

According to an aspect of the present disclosure, a driving assistance method includes receiving crosswalk-related traffic information by performing V2X (Vehicle to Everything) communication with a signal controller, identifying whether a pedestrian is present in a crosswalk based on the crosswalk-related traffic information, determining, when the pedestrian is present in the crosswalk, a time point at which to provide the crosswalk-related traffic information to a driver based on driving information of a vehicle and driver age information, and providing the crosswalk-related traffic information to the driver at the determined time point.

In an embodiment, the determining of the time point may include determining a perception-reaction time of the driver based on the driver age information, determining a stopping sight distance of the vehicle based on the perception-reaction time of the driver and the driving information, and determining the time point at which to provide the crosswalk-related traffic information to the driver based on the stopping sight distance.

In an embodiment, the determining of the stopping sight distance may include determining the stopping sight distance of the vehicle in further consideration of weather information.

In an embodiment, the crosswalk-related traffic information may include presence or absence of pedestrians, vehicle signal change information, and vehicle stop signal remaining time information.

In an embodiment, the determining of the time point may include advancing the time point as the driver's age increases based on preset perception-reaction times by age group.

In an embodiment, the driving assistance method may further include continuously monitoring the driving information of the vehicle.

In an embodiment, the driving assistance method may further include predicting whether the vehicle is about to violate a vehicle stop signal based on the driving information of the vehicle.

In an embodiment, the driving assistance method may further include performing V2P (Vehicle to Pedestrian) communication with a pedestrian terminal of the pedestrian to provide a warning signal to the pedestrian terminal when the vehicle is predicted to violate the vehicle stop signal.

In an embodiment, the driving assistance method may further include providing an emergency warning signal to the driver when the vehicle is predicted to violate the vehicle stop signal.

In an embodiment, the driving assistance method may further include performing emergency braking when it is identified that braking control of the vehicle is not performed based on the driving information after providing the emergency warning signal to the driver.

### BRIEF DESCRIPTION OF THE DRAWINGS

The above and other objects, features and advantages of the present disclosure will be more apparent from the following detailed description taken in conjunction with the accompanying drawings:

FIG. 1 schematically illustrates a configuration of a driving assistance system including a driving assistance device according to an embodiment of the present disclosure;

FIG. 2 is a block diagram schematically illustrating a configuration of a vehicle including a driving assistance device according to an embodiment of the present disclosure;

FIG. 3 is a block diagram schematically illustrating a configuration of a signal controller according to an embodiment of the present disclosure;

FIG. 4 is a flowchart for describing a driving assistance method according to an embodiment of the present disclosure;

FIG. 5 is a flowchart for describing sub-operations for determining a traffic information provision time point among the steps of the driving assistance method according to an embodiment of the present disclosure;

FIG. 6 is a flowchart for describing additional operations after the operation of providing crosswalk-related traffic information to a driver in the driving assistance method according to an embodiment of the present disclosure;

FIG. 7 schematically illustrates a configuration of a driving assistance system according to another embodiment of the present disclosure;

FIG. 8 is a block diagram schematically illustrating a configuration of a server according to another embodiment of the present disclosure;

FIG. 9 is a flowchart for describing a driving assistance method according to another embodiment of the present disclosure; and

FIG. 10 is a diagram showing a screen that receives crosswalk-related traffic information according to an embodiment of the present disclosure and provides a notification to a driver through a navigation device for a vehicle.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

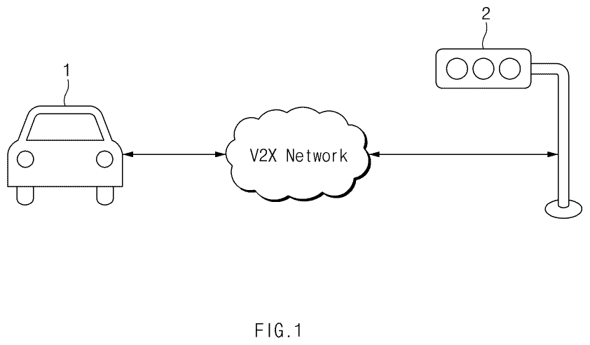

Hereinafter, embodiments of the present disclosure will be described in detail with reference to FIGS. 1 to 10.

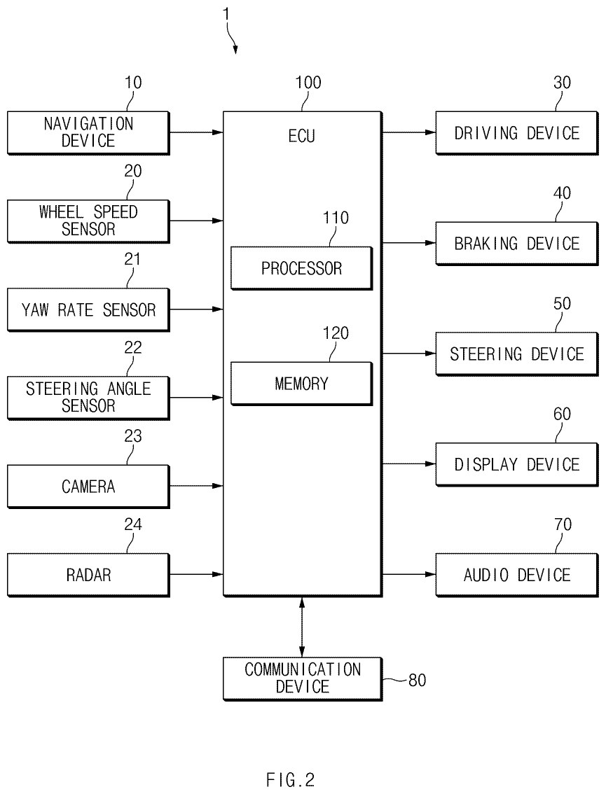

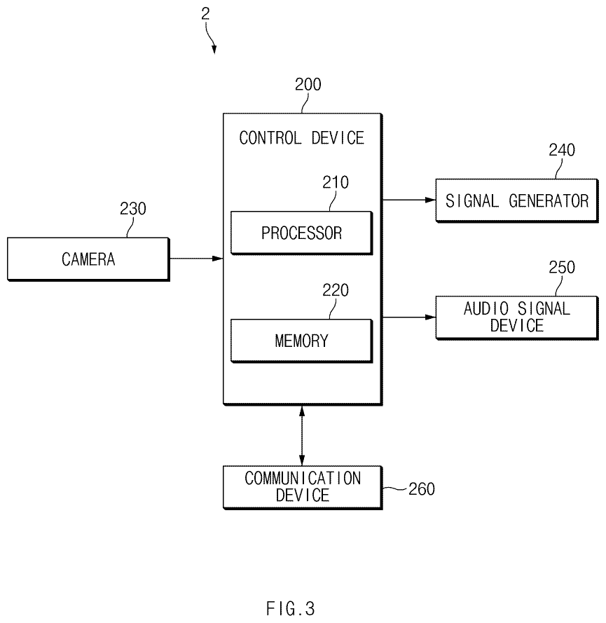

FIG. 1 schematically illustrates a configuration of a driving assistance system including a driving assistance device according to an embodiment of the present disclosure, FIG. 2 is a block diagram schematically illustrating a configuration of a vehicle including a driving assistance device according to an embodiment of the present disclosure, and FIG. 3 is a block diagram schematically illustrating a configuration of a signal controller according to an embodiment of the present disclosure.

Referring to FIG. 1, a driving assistance system according to an embodiment of the present disclosure may be implemented in the form of a vehicle 1 and a signal controller 2.

As used in the present disclosure, the term “signal controller” may refer to a signal controller located at a specified crosswalk. For example, the signal controller may be a signal controller located at crosswalks around off-ramps and ramps.

According to an embodiment, the vehicle 1 may transmit driving information and vehicle information to the signal controller 2. The driving information may include, but is not limited to, real-time GPS location coordinates of the vehicle 1, driving speed, acceleration and deceleration data, and navigation path information. The vehicle information may include, but is not limited to, a vehicle identification number (VIN), driver age information, vehicle make, model, year information, vehicle size, and weight data.

The vehicle 1 may receive crosswalk-related traffic information from the signal controller 2. The crosswalk-related traffic information may include, but is not limited to, the presence or absence of pedestrians, vehicle signal change information, and vehicle stop signal remaining time information. For example, the crosswalk-related traffic information may further include weather information in the vicinity of the signal controller 2.

Referring to FIG. 2, the driver of the vehicle 1 may perform necessary controls while receiving the crosswalk-related traffic information including the presence or absence of pedestrians, vehicle signal change information, vehicle stop signal remaining time information, and weather information being guided by a navigation device 10, a display device 60, or an audio device 70.

Referring to FIG. 3, the signal controller 2 may recognize a pedestrian based on image data acquired through a camera 230 installed around an off-ramp and a ramp and having a constant detection field of view, acquire location information of the pedestrian based on the image data and the recognized pedestrian and transmit the location information of the pedestrian to the vehicle 1 which is driving toward the off-ramp.

To this end, the vehicle 1 and the signal controller 2 may exchange information through V2X (Vehicle to Everything communication) communication.

The V2X communication refers to a technology that enables exchange of information in both directions between a vehicle and surrounding infrastructure. For example, V2X may be collectively referred to as wireless communication between vehicles (V2V, Vehicle to Vehicle), wireless communication between vehicles and infrastructure (V2I, Vehicle to Infrastructure, I2V, Infrastructure to Vehicle), in-vehicle networking (IVN), and communication between vehicles and mobile terminals (V2P, Vehicle to Pedestrian).

Referring again to FIG. 2, the vehicle 1 according to an embodiment of the present disclosure may include the navigation device 10, a wheel speed sensor 20, a yaw rate sensor 21, a steering angle sensor 22, a camera 23, a radar 24, a driving device 30, a braking device 40, a steering device 50, the display device 60, the audio device 70, a communication device 80, and an electronic control unit (ECU) 100. In this case, the electronic control unit 100 of the vehicle may be integrally formed with internal control units of the vehicle, or may be implemented as a separate device and connected to the control units of the vehicle by separate connection means.

The navigation device 10 is a device for positioning and routing the vehicle 1 and may include a GPS receiver, a processor, a memory, a display, and the like. The navigation device 10 may calculate the current location of the vehicle 1 and generate a path to a destination entered by the driver, by using GPS signals and stored map data. When generating the path, the navigation device 10 may provide an optimal path in consideration of road types, distances, estimated travel times, and the like. Further, the navigation device 10 may receive real-time traffic information and update a path. The navigation device 10 may determine the locations of key points along the path, such as intersections, motorway on- and off-ramps, ramps, and the like, and provide voice or screen instructions to the driver. The navigation device 10 may generate navigation path information that is included in the driving information.

The wheel speed sensor 20, the yaw rate sensor 21, and the steering angle sensor 22 may acquire various sensor data related to an occurring movement and state of the vehicle 1 during driving.

For example, the wheel speed sensor 20 may be installed on each wheel of the vehicle ito acquire wheel speed data for each wheel and provide the wheel speed data to the electronic control unit (ECU) 100.

The yaw rate sensor 21 may measure an angular velocity of rotation about the vertical axis of the vehicle 1 and provide the angular velocity to the electronic control unit (ECU) 100.

The steering angle sensor 22 may be installed on the steering column or steering wheel of the vehicle 1 to acquire data related to the rotation angle and rotation speed of the steering wheel and provide the data to the electronic control unit 100.

The camera 23 and the radar 24 may be installed at the front, rear, and/or side of the vehicle 1 to identify or detect an object with a detection field of view outside the vehicle 1.

The driving device 30 may drive an engine or a motor to move the vehicle 1 in response to a driver's input force for an accelerator pedal.

The braking device 40 may decelerate the vehicle 1 in response to the input force applied to a brake pedal in accordance with the driver's intention to brake.

The steering device 50 may control the steering of the vehicle 1 in response to a wheel operation of the driver.

The display device 60 may include a center fascia, a cluster, a head-up display, or the like, and may provide various information and entertainment to the driver via images and sound. For example, the display device 60 may provide the driver with vehicle driving information, warning messages, and the like.

The audio device 70 may include a plurality of speakers and may provide various information and entertainment to the driver via sound. For example, the audio device 70 may provide the driver with vehicle driving information, warning messages, and the like.

The communication device 80 may perform V2X communication with the signal controller 2 and may transmit driving information and vehicle information of the vehicle 1 and receive crosswalk-related traffic information.

The communication device 80 may include V2X functionality. To this end, the communication device 80 may support Dedicated Short-Range Communications (DSRC), Cellular V2X (C-V2X), or the like.

Herein, DSRC is an ultra-short-range communication technology that provides low latency and high reliability, and is primarily used in traffic safety applications.

C-V2X is a V2X communication technology based on LTE and 5G cellular networks, which provides a wider range and better communication performance.

As described above, the communication device 80 may be equipped with at least one of DSRC and C-V2X technologies to support V2X functionality. To this end, the communication device 80 may be the communication device 80 in which a communication chipset and antennas that support V2X are incorporated.

In addition, the communication device 80 may support the IEEE 802.11p protocol for DSRC communication, the LET-V protocol for C-V2X communication, the Basic Safety Message (BSM) protocol, which is a message format that transmits basic information such as the state, speed, direction or the like of a vehicle, the Standard SAE J2735 protocol for sets of V2X messages defining various message formats and exchange patterns, and the like.

In addition, the communication device 80 may be integrated with a CBF (Contention-Based Forwarding) algorithm that determines a target to which a data packet is to be transmitted to support V2X communication, and an ATB (Adaptive Traffic Beacon) algorithm that adjusts a message transmission speed according to traffic conditions.

An electronic control unit (ECU) or controller 100 may be connected to the navigation device 10, the driving device 30, the braking device 40, the steering device 50, the display device 60, the audio device 70, the communication device 80, and/or the plurality of sensors 20, 21, 22, 23, and 24 through a vehicle communication network (NT) to transmit various control signals.

The electronic control unit or controller 100 may include a processor 110 and a memory 120.

The processor 110 may provide crosswalk-related traffic information received through the communication device 80 to the navigation device 10, or control the display device 60 and/or the audio device 70 based on the crosswalk-related traffic information to play back information informing the driver that a pedestrian is present in a crosswalk and that the signal controller 2 for the crosswalk is about to generate a vehicle stop signal.

The processor 110 may identify whether a pedestrian is present in the crosswalk based on the crosswalk-related traffic information. The crosswalk-related traffic information may include the presence or absence of a pedestrian, vehicle signal change information, vehicle stop signal remaining time information, and weather information.

For example, the vehicle signal change information may include a current vehicle signal of the crosswalk (e.g., green, red, orange) generated through a signal generator 240 and a vehicle signal to be changed (e.g., orange, green, red). The vehicle stop signal remaining time information may refer to a time remaining until the current vehicle signal changes to a red signal, which is a vehicle stop signal. For example, when the current vehicle signal is green and the vehicle stop signal remaining time information is 7 seconds, it means that there are 7 seconds left until the current vehicle signal, which is a green signal, changes to the vehicle stop signal, which is a red signal.

The processor 110 may determine a time point to provide the crosswalk-related traffic information to the driver based on the driver's age information included in the vehicle information. The vehicle information may include a vehicle identification number (VIN), driver age information, vehicle make, model, year information, and vehicle size and weight data.

The processor 110 may determine the driver's perception-reaction time based on the driver age information, and determine the stopping sight distance of the vehicle 1 based on the driver's perception-reaction time and driving information. The processor 110 may determine a time point to provide the driver with the crosswalk-related traffic information based on the stopping sight distance.

The perception-reaction time is the sum of a perception time and a reaction time.

The perception time refers to a time interval between the time when the driver recognizes the occurrence of a situation requiring braking and the time when the RPM starts to decrease after the driver takes his/her foot off the accelerator pedal.

The reaction time refers to a time interval between the time when the driver takes his foot off the accelerator pedal and the time when the driver starts to step the brake.

In summary, the perception-reaction time refers to the time interval between the time when the driver first reacts to an object or situation reflected in the driver's view, and refers to the reaction time that goes through the four stages of perception, identification, judgment, and reaction

In Korea, as a design standard, a perception-reaction time of 2.5 seconds may be generally used, which is specified by AASHTO (American Association of State Highway and Transportation Officials). Here, the perception time is 1.5 seconds and the reaction time is 1 second.

Factors that affect the perception-reaction time may include the driver's age, driver's expectations, gender, field of view, and the like.

In particular, the driver's age may be a major factor that affects the perception-reaction time.

Table 1 below shows the perception-reaction time by driver age.

TABLE 1

| | Age | | | | | | | | |
|---|---|---|---|---|---|---|---|---|---|
| | | | 65-66 | 67-68 | 69-70 | 71-72 | 73-74 | 75-76 | 77-78 |
| | 20s to | | years | years | years | years | years | years | years |
| | 40s | 50s | old | old | old | old | old | old | old |
| 85^{th} | About | About | 2.509 | 2.477 | 2.488 | 2.511 | 3.090 | 3.210 | 3.149 |
| percentile | 1.3 | 2.1 | | | | | | | |
| (unit: | | | | | | | | | |
| seconds) | | | | | | | | | |

| | Age | | | |
|---|---|---|---|---|
| | 79-80 | 81-82 | 83-84 | |
| | years | years | years | 85 years |
| | old | old | old | or older |
| 85^{th} | 3.216 | 3.182 | 2.971 | 3.604 |
| percentile | | | | |
| (unit: | | | | |
| seconds) | | | | |

The Stopping Sight Distance (SSD) refers to the sum of the distance traveled by a vehicle while the driver perceives an obstacle ahead, judges the obstacle as hazardous, and activates the braking device (perception-reaction distance), and the distance the vehicle travels after the brakes are applied until the vehicle comes to a complete stop (braking distance).

The distance traveled by the vehicle while the driver perceives an obstacle ahead, judges the obstacle as hazardous, and activates the braking device-referred to as the perception-reaction distance—may also be expressed as the distance the vehicle travels during the driver's perception-reaction time.

The stopping sight distance (SSD) on a flat road, i.e. a road with no slope may be calculated using the following formula:

$$S S D = d 1 + d 2 = \frac{V}{3.6} t + \frac{{V}^{2}}{254 f}$$

Here, SSD is the stopping sight distance (m), d₁ is the perception-reaction distance (m), d₂ is the braking distance (m), “V” is the driving speed (km/h), “t” is the perception-reaction time (seconds), and “f” is the longitudinal skid resistance coefficient.

In an embodiment, considering road conditions with frozen or snowy surfaces, a longitudinal skid resistance coefficient (f) of 0.15 may be applied. In other words, the longitudinal skid resistance coefficient (f) may be applied to account for hazardous road conditions that make normal braking difficult.

Table 2 below shows skid resistance coefficients byroad surface condition.

TABLE 2

| | | Slippery Road with Rain, | Frozen Road, Slush, and |
|---|---|---|---|
| Friction Coefficient (f) | Regular Road | Oil, or Sand | Icy Road |
| Range (0 to 1, with | 0.8~0.9 | 0.5~0.6 | 0.2~0.3 |
| values closer to 1 | | | |
| indicating higher | | | |
| friction) | | | |
| Driving Conditions | Able to drive smoothly at | Caution required for | Friction coefficient is very |
| | the design speed and speed | absolute deceleration and | low, so caution required |
| | limit | sudden braking | for absolute deceleration |
| | | | and sudden braking |

In this way, the processor 110 may determine the stopping sight distance of the vehicle 1 through the driving speed of the vehicle, the driver's perception-reaction time according to the driver's age, and the longitudinal skid resistance coefficient according to the road condition.

In particular, to enable for the driver to react to a pedestrian existing around the crosswalk near an off-ramp and a ramp and a vehicle signal changing through a pedestrian-sensitive signal and to stop safely, the crosswalk-related traffic information may need to be provided to the driver of the vehicle 1 in advance.

For example, assuming that a driver in his 20s and a driver in his 70s are each driving at a speed of 50 kph on a general road, the perception-reaction time of the driver in his 20s is about 1.3 seconds, and the perception-reaction time of the driver in his 70s is about 2.5 seconds.

Accordingly, the stopping sight distance of the driver in his 20s is about 30.3 m, and the stopping sight distance of the driver in his 70s is about 47.0 m. Therefore, compared to the driver in his 20s, the driver in his 70s may need to secure an additional stopping sight distance of about 16.7 m.

The processor 110 may need to shift the time point to provide the crosswalk-related traffic information to a relatively earlier time point when the driver of the vehicle 1 is an elderly driver, such as a driver in his 70s, based on the difference in the stopping sight distance (approximately 16.7 m), compared to when the driver is in his 20s.

According to an embodiment, when determining the stopping sight distance of the vehicle 1, the processor 110 may further consider weather information, i.e., weather affecting the road surface condition, as described above.

The processor 110 may provide the crosswalk-related traffic information to the driver of the vehicle 1 through the navigation device 10 at the determined time point.

According to an embodiment, after providing the crosswalk-related traffic information to the driver of the vehicle 1, the processor 110 may continuously monitor the driving information of the vehicle 1.

According to an embodiment, the processor 110 may predict whether the vehicle 1 is about to violate a vehicle stop signal based on the driving information of the vehicle 1. For example, after the processor 110 provides the crosswalk-related traffic information to the driver of the vehicle 1, the processor 110 may continuously compare a stopping sight distance predicted based on the driving information of the vehicle 1 with the distance between the vehicle 1 and the crosswalk to determine whether the predicted stopping sight distance is greater than the distance between the vehicle 1 and the crosswalk.

According to an embodiment, when the predicted stopping sight distance is greater than the distance between the vehicle 1 and the crosswalk, the processor 110 may control the communication device 80 to perform V2P communication with the pedestrian terminal (not shown) of a pedestrian to provide a warning signal to the pedestrian terminal.

According to an embodiment, when the predicted stopping sight distance is greater than the distance between the vehicle 1 and the crosswalk, the processor 110 may provide an emergency warning signal to the driver of the vehicle 1.

According to an embodiment, the processor 110 may provide an emergency warning signal to the driver of the vehicle 1 in the form of a visual and/or audible signal through the display device 60 and/or the audio device 70.

According to an embodiment, when the processor 110 identifies that the braking control of the vehicle 1 is not performed, based on the driving information of the vehicle 1 after providing the emergency warning signal to the driver of the vehicle 1, the processor 110 may perform emergency braking.

To this end, the processor 110 may identify whether the braking control of the vehicle 1 is performed based on the current speed of the vehicle 1 acquired by the wheel speed sensor 20.

According to one embodiment, when the processor 110 identifies that the braking control of the vehicle 1 is not performed, based on the driving information of the vehicle 1 after providing the emergency warning signal to the driver of the vehicle 1, the processor 110 may transmit predicted information indicating that the vehicle 1 is about to violate a vehicle stop signal to the signal controller 2.

In this way, the processor 110 may process information related to the movement or driving of the vehicle based on signals and/or data acquired from the various sensors 20, 21, 22, 23, and 24 of the vehicle 1 and control at least one of the driving device 30, the braking device 40, the steering device 50, the display device 60, the audio device 70, and the communication device 80 to determine the time point at which to provide the crosswalk-related traffic information to the driver based on driver age information.

The memory 120 may store various data, programs, and information, such as a processing algorithm for determining a stopping sight distance, prediction of a vehicle stop signal violation of the vehicle 1, and storage of crosswalk-related traffic information received from the signal controller 2, so as to assist the operation of a processor 210.

Referring to FIG. 3, the signal controller 2 may include the camera 230, the signal generator 240, an audio signal device 250, a communication device 260, and a control device 200.

The camera 230 may have a constant detection field of view for the surroundings of a crosswalk where the signal controller 2 is located. The camera 230 may obtain image data for the constant detection field of view.

To this end, the camera 230 may include a plurality of lenses and an image sensor. The image sensor may include a plurality of photodiodes that convert light into an electrical signal, and the plurality of photodiodes may be arranged in a two-dimensional matrix.

The image data may include information about the vehicle 1, a pedestrian, a cyclist, or a lane (a marker that distinguishes a lane).

According to an embodiment, the camera 230 may be a camera having a 360-degree detection field of view.

The camera 230 may include an image processor (not shown) that obtains image data from the image sensor of the camera and detects and identifies objects existing around monitoring target lanes based on the processing of the image data. For example, the image processor may identify the vehicle 1, a pedestrian, a cyclist, a lane, or the like on the image plane using image processing.

Alternatively, the image processor may perform only the role of acquiring image data from the image sensor of the camera and generating an image through the image data, like a general camera. Operations such as detecting, identifying, and classifying an object from the image acquired from the image data may be performed by the processor 210 of the control device 200 to be described below.

The signal generator 240 may generate or change a crosswalk signal according to the control of the control device 200.

The audio signal device 250 may provide a warning signal to a pedestrian according to the control of the control device 200.

The control device 200 may be installed inside or outside the support of the signal controller 2 and connected to the camera 230, the signal generator 240, the audio signal device 250, and the communication device 260, and may control the camera 230, the signal generator 240, the audio signal device 250, and the communication device 260.

To this end, the control device 200 may include the processor 210 and a memory 220.

The processor 210 may recognize a pedestrian based on the image data of the camera 230 and classify the type of the pedestrian.

The processor 210 may detect and identify an object existing around the monitoring target lanes by performing processing on the image data. For example, the processor 210 may identify the vehicle 1, a pedestrian, a cyclist, a lane, or the like on the image plane.

In this way, the processor 210 may determine whether a pedestrian exists based on the image data.

When a pedestrian is present in a crosswalk, the processor 210 may transmit crosswalk-related traffic information, including whether the pedestrian exists, to the vehicle 1.

The crosswalk-related traffic information may include the presence or absence of a pedestrian, vehicle signal change information, vehicle stop signal remaining time information, and weather information.

According to an embodiment, the processor 210 may receive predicted information indicating that the vehicle 1 is about to violate a vehicle stop signal from the vehicle 1, and when a crosswalk signal has not changed to the vehicle stop signal, i.e., a walk signal, the processor 210 may delay the change to the vehicle stop signal for a predetermined time such that the vehicle stop signal is generated after the vehicle 1 passes the crosswalk.

According to an embodiment, when the processor 210 receives the predicted information indicating that the vehicle 1 is about to violate the vehicle stop signal from the vehicle 1, the processor 210 may control the audio signal device 250 to provide a warning signal to a pedestrian on the crosswalk.

The memory 220 may store various data, programs, and information, such as an image processing algorithm for pedestrian recognition, driving information received from the vehicle 1, and predicted information indicating that a vehicle is about to violate a vehicle stop signal, or the like so as to assist the operation of the processor 210.

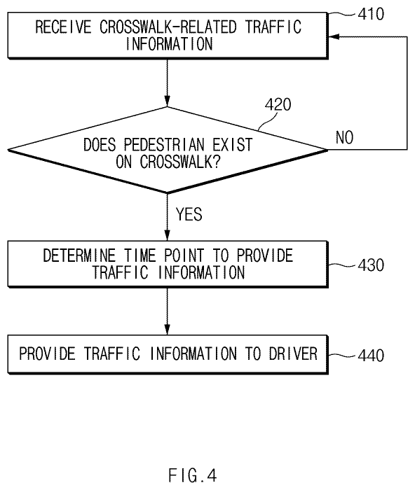

Hereinafter, a driving assistance method according to one embodiment of the present disclosure will be specifically described with reference to FIGS. 4 to 6.

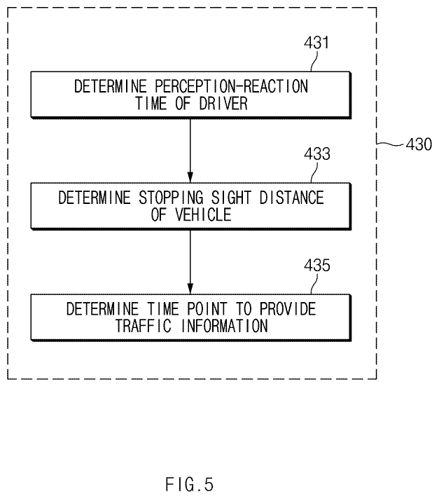

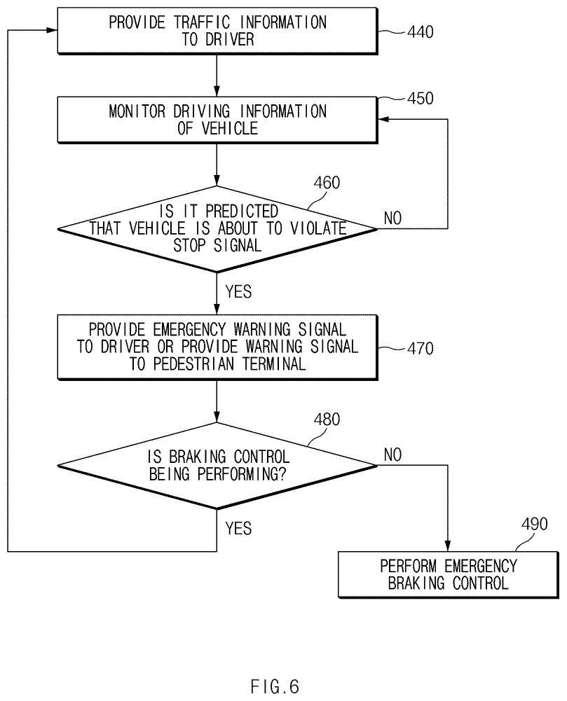

FIG. 4 is a flowchart for describing a driving assistance method according to an embodiment of the present disclosure, FIG. 5 is a flowchart for describing sub-operations for determining a traffic information provision time point among the steps of the driving assistance method according to an embodiment of the present disclosure, and FIG. 6 is a flowchart for describing additional steps after the operation of providing crosswalk-related traffic information to a driver in the driving assistance method according to an embodiment of the present disclosure.

Referring to FIG. 4, a driving assistance method according to an embodiment of the present disclosure may include receiving crosswalk-related traffic information by performing V2X communication with the signal controller 2 (410), identifying whether a pedestrian exists in a crosswalk based on the crosswalk-related traffic information (420), determining a time point at which to provide the crosswalk-related traffic information to a driver based on driving information of the vehicle 1 and driver age information (430), and providing the crosswalk-related traffic information to the driver at the determined time point.

In the operation of receiving the crosswalk-related traffic information by performing V2X communication with the signal controller 2 (410), the communication device 80 of the vehicle 1 may receive the crosswalk-related traffic information via V2X communication with the communication device 260 of the signal controller 2.

In the operation of identifying whether a pedestrian exists in the crosswalk based on the crosswalk-related traffic information, the electronic control unit (or controller) 100 of the vehicle 1 may identify whether a pedestrian exists in the crosswalk based on the presence or absence of the pedestrian included in the crosswalk-related traffic information.

The operation of determining the time point at which to provide the crosswalk-related traffic information to the driver is provided to the driver based on the driving information of the vehicle 1 and the driver age information when a pedestrian exists in the crosswalk (430) will be described in detail later with reference to FIG. 5.

In the operation of providing the crosswalk-related traffic information to the driver at the determined time point, the electronic control unit (or controller) 100 of the vehicle 1 may provide the crosswalk-related traffic information to the driver of the vehicle 1 via the navigation device 10 at the determined time point.

Referring to FIG. 5, the operation of determining the time point at which to provide the crosswalk-related traffic information to the driver (430) may include determining a perception-reaction time of the driver based on driver age information (431), determining a stopping sight distance of the vehicle 1 based on the perception-reaction time and driving information of the driver (433), and determining a time point at which to provide the crosswalk-related traffic information to the driver based on the stopping sight distance (435).

The electronic control unit (or controller) 100 of the vehicle 1 may determine the perception-reaction time of the driver based on the driver age information (431). In this case, the electronic control unit (or controller) 100 may advance the time point as the driver's age increases based on a preset perception-reaction time by age group.

In the operation of determining a stopping sight distance of the vehicle 1 based on the driver's perception-reaction time and driving information, the electronic control unit (or controller) 100 may determine the sum of a perception-reaction distance and a braking distance as the stopping sight distance. Here, the perception-reaction distance may refer to the distance traveled by the vehicle 1 during the perception-reaction time by age group of the driver of the vehicle 1, and the braking distance may refer to the distance until the driver operates the braking device 40 to bring the vehicle 1 to a complete stop.

In the operation of determining the time point at which to provide the crosswalk-related traffic information to the driver based on the stopping sight distance, the electronic control unit (or controller) 100 may determine the time point at which to provide the crosswalk-related traffic information to the driver such that the stopping sight distance of the vehicle 1 is less than the distance between the current location of the vehicle 1 and the crosswalk. For example, the time point at which to provide the crosswalk-related traffic information may be determined such that the stopping sight distance is greater than the distance between the current location of the vehicle 1 and the crosswalk by a predetermined distance.

Referring to FIG. 6, after providing the crosswalk-related traffic information to the driver at the determined time point, the driving assistance method may further include continuously monitoring the driving information of the vehicle 1 (450), predicting whether the vehicle 1 is about to violate a stop signal based on the driving information of the vehicle 1 (460), providing a warning signal to a pedestrian terminal or providing an emergency warning signal to the driver when the vehicle 1 is predicted to violate the stop signal (470) and after providing the emergency warning signal to the driver, when it is identified that the braking control of the vehicle 1 is not performed based on the driving information (480), performing emergency braking (490).

In the operation of continuously monitoring the driving information of the vehicle 1 (450), the electronic control unit (or controller) 100 may continuously monitor the driving information of the vehicle 1.

In the operation of predicting whether the vehicle 1 is about to violate a stop signal based on the driving information of the vehicle 1 (460), the electronic control unit (or controller) 100 may compare the stopping sight distance predicted based on the driving information of the vehicle 1 with a distance between the vehicle 1 and the crosswalk to determine whether the predicted stopping sight distance is greater than the distance between the vehicle 1 and the crosswalk. When the predicted stopping sight distance is greater than the distance between the vehicle 1 and the crosswalk, the vehicle 1 may be predicted to violate the stop signal. When the predicted stopping sight distance is less than the distance between the vehicle 1 and the crosswalk, the vehicle 1 may be predicted not to violate the stop signal.

In the operation of providing the warning signal to the pedestrian terminal or providing the emergency warning signal to the driver when the vehicle 1 is predicted to violate the stop signal (470), the electronic control unit (or controller) 100 may provide a warning signal by performing V2P communication with the pedestrian terminal of the pedestrian, or may provide an emergency warning signal to the driver of the vehicle 1 in the form of a visual and/or audible signal via the display device 60 and/or the audio device 70.

In the operation of identifying that the braking control of the vehicle 1 is not performed based on the driving information after providing the emergency warning signal to the driver (480), the electronic control unit (or controller) 100 may identify whether the braking control of the vehicle 1 is performed based on the current speed of the vehicle 1 obtained by the wheel speed sensor 20.

In the operation of performing emergency braking (490), the electronic control unit (or controller) 100 may perform emergency braking of the vehicle 1 on behalf of the driver.

In addition, after providing the emergency warning signal to the driver, when the electronic control unit (or controller) 100 identifies that the braking control of the vehicle 1 is not performed based on the driving information (480), the electronic control unit (or controller) 100 may transmit predicted information indicating that the vehicle 1 is about to violate a vehicle stop signal to the signal controller 2. Accordingly, the control device 200 of the signal controller 2 may provide a warning signal to a pedestrian in the crosswalk based on the predicted information indicating that the vehicle 1 is about to violate the vehicle stop signal. Further, the control device 200 of the signal controller 2 may delay the change to the vehicle stop signal by a predetermined time to generate the vehicle stop signal after the vehicle 1 passes through the crosswalk when the crosswalk signal has not changed to the vehicle stop signal, i.e., the walk signal based on the predicted information indicating that the vehicle 1 is about to violate the vehicle stop signal.

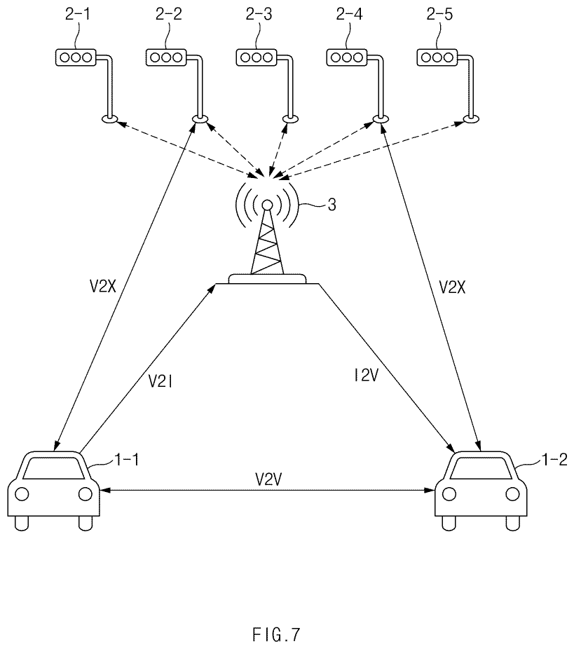

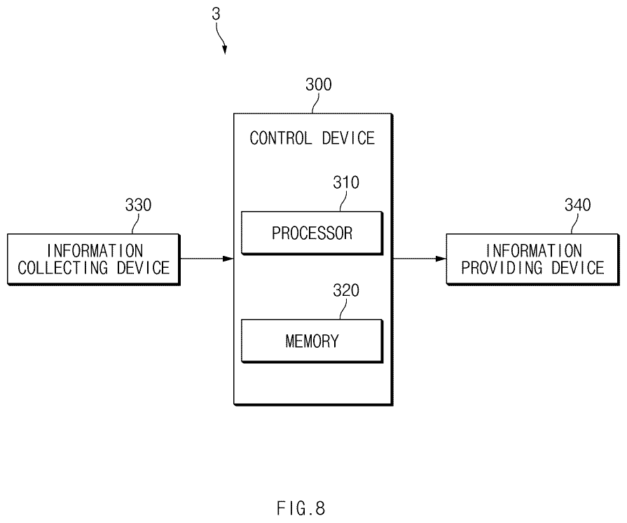

Hereinafter, a driving assistance system according to another embodiment of the present disclosure will be described in detail with reference to FIGS. 7 to 8.

FIG. 7 is a block diagram schematically illustrating a configuration of a driving assistance system according to another embodiment of the present disclosure, and FIG. 8 is a block diagram schematically illustrating a configuration of a server according to another embodiment of the present disclosure.

In the following, descriptions for the configuration of the vehicle 1 and the configuration of the signal controller 2 are replaced by the descriptions described above in FIGS. 2 and 3 to avoid unnecessary duplication and for ease of understanding.

Referring to FIG. 7, a server 3 may perform V2I and I2V communications with vehicles 1-1 and 1-2. Each vehicle 1-1 or 1-2 may perform V2X communication with the server 3 and at least one signal controller 2-1, 2-2, 2-3, 2-4, or 2-5.

According to an embodiment, the server 3 may be a server of a roadside base station.

The vehicle 1-1 or 1-2 may transmit driving information and vehicle information to the server 3.

The server 3 may identify a nearest signal controller 2 located on the traveling path of the vehicle 1-1 or 1-2 based on navigation path information included in the driving information.

The server 3 may provide the vehicle information to the nearest signal controller 2. However, embodiments are not limited thereto, and the server 3 may further provide driving information of the vehicle 1-1 or 1-2, traffic situation information in the vicinity of the nearest signal controller 2, weather information, and the like.

The nearest signal controller 2 may identify the vehicle 1-1 or 1-2 based on the vehicle information received from the server 3, and perform V2X communication with the vehicle 1-1 or 1-2.

The nearest signal controller 2 may also identify whether a pedestrian exists in the crosswalk.

When a pedestrian exists in the crosswalk, the nearest signal controller 2 may transmit crosswalk-related traffic information, including the presence or absence of the pedestrian, to the vehicle 1-1 or 1-2.

The crosswalk-related traffic information may include the presence or absence of the pedestrian, vehicle signal change information, and vehicle stop signal remaining time information.

In addition, the crosswalk-related traffic information may further include weather information in the vicinity of the nearest signal controller 2 received from the server 3. For example, the weather information may include precipitation information including rainfall amount, snowfall information including snowfall amount, and the like.

According to an embodiment, the nearest signal controller 2 may receive predicted information indicating that the vehicle 1-1 or 1-2 is about to violate a vehicle stop signal from the vehicle 1-1 or 1-2 and when the crosswalk signal has not yet changed to the vehicle stop signal, delay the change to the vehicle stop signal for a predetermined time to allow the vehicle stop signal to be generated after the vehicle 1-1 or 1-2 passes through the crosswalk.

According to an embodiment, when the nearest signal controller 2 receives predicted information indicating that the vehicle 1-1 or 1-2 is about to violate the vehicle stop signal from the vehicle 1-1 or 1-2, the nearest signal controller 2 may provide a warning signal to a pedestrian on a crosswalk.

Referring to FIG. 8, the server 3 may include an information collecting device 330, an information providing device 340, and a control device 300.

The information collecting device 330 may collect traffic situation information, weather information, signal controller information, vehicle information, driving information, or the like in real time.

The traffic situation information may include information related to road conditions or traffic accidents near each signal controller, but is not limited thereto.

The weather information may include, but is not limited to, for example, precipitation information including precipitation amount, snowfall information including snowfall amount.

The signal controller information may include, but is not limited to, location information, state information, or the like of each signal controller.

The vehicle information may include, but is not limited to, a vehicle identification number (VIN), driver age information, vehicle make, model, year information, and vehicle size and weight data.

The driving information may include, but is not limited to, real-time GPS location coordinates of the vehicle 1, driving speed, acceleration and deceleration data, and navigation path information.

The control device 300 may process information collected by the information collecting device 330. According to an embodiment, the control device 300 may identify the neatest signal controller 2 located on the traveling path of the vehicle 1-1 or 1-2 based on the driving information and vehicle information of the vehicle 1-1 or 1-2 received from the vehicle 1-1 or 1-2.

The information providing device 340 may provide vehicle information of the vehicle 1-1 or 1-2 to the identified nearest signal controller 2 under the control of the control device 300. However, embodiments are not limited thereto, and the information providing device 340 may further provide driving information of the vehicle 1-1 or 1-2, traffic situation information around the nearest signal controller 2, weather information, or the like to the nearest signal controller 2.

The nearest signal controller 2 may recognize a pedestrian based on the image data of the camera 230 and classify the type of pedestrian.

The nearest signal controller 2 may determine whether a pedestrian exists based on the image data.

When a pedestrian is present in the crosswalk, the nearest signal controller 2 may transmit crosswalk-related traffic information, including information indicating whether or not the pedestrian exists, to the vehicle 1-1 or 1-2.

The crosswalk-related traffic information may include, but is not limited to, the presence or absence of pedestrians, vehicle signal change information, and vehicle stop signal remaining time information.

The electronic control unit (or controller) 100 of the vehicle 1-1 or 1-2 may determine the driver's perception-reaction time based on driver age information, and determine the stopping sight distance of the vehicle 1-1 or 1-2 based on the driver's perception-reaction time and the driving information. The electronic control unit (or controller) 100 of the vehicle 1-1 or 1-2 may determine a time point at which to provide crosswalk-related traffic information to the driver based on the stopping sight distance.

According to an embodiment, when determining the stopping sight distance of the vehicle 1-1 or 1-2, weather information, i.e., weather affecting the road surface condition, as described above, may be further considered.

According to an embodiment, the electronic control unit (or controller) 100 of the vehicle 1-1 or 1-2 may continuously monitor the driving information of the vehicle 1-1 or 1-2 after providing the crosswalk-related traffic information to the driver.

According to an embodiment, the electronic control unit (or controller) 100 of the vehicle 1-1 or 1-2 may predict whether the vehicle 1-1 or 1-2 is about to violate a vehicle stop signal based on the driving information of the vehicle 1-1 or 1-2. For example, after the electronic control unit (or controller) 100 of the vehicle 1-1 or 1-2 provides the crosswalk-related traffic information to the driver, the electronic control unit (or controller) 100 of the vehicle 1-1 or 1-2 may continuously compare a stopping sight distance predicted based on the driving information of the vehicle 1-1 or 1-2 with the distance between the vehicle 1-1 or 1-2 and the crosswalk to determine whether the predicted stopping sight distance is greater than the distance between the vehicle 1-1 or 1-2 and the crosswalk.

According to an embodiment, when the predicted stopping sight distance is greater than the distance between the vehicle 1-1 or 1-2 and the crosswalk, the electronic control unit (or controller) 100 of the vehicle 1-1 or 1-2 may provide a warning signal to a pedestrian terminal by performing V2P communication with the pedestrian terminal of the pedestrian.

According to an embodiment, when the predicted stopping sight distance is greater than the distance between the vehicle 1-1 or 1-2 and the crosswalk, the electronic control unit (or controller) 100 of the vehicle 1-1 or 1-2 may provide an emergency warning signal to the driver.

According to an embodiment, the electronic control unit (or controller) 100 of the vehicle 1-1 or 1-2 may provide an emergency warning signal to the driver of the vehicle 1 in the form of a visual and/or audible signal through the display device 60 and/or the audio device 70.

According to an embodiment, when it is identified that the braking control of the vehicle 1-1 or 1-2 is not performed, based on the driving information of the vehicle 1-1 or 1-2 after providing the emergency warning signal to the driver of the vehicle 1-1 or 1-2, the electronic control unit (or controller) 100 of the vehicle 1-1 or 1-2 may perform emergency braking.

According to an embodiment, when it is identified that the braking control of the vehicle 1-1 or 1-2 is not performed, based on the driving information of the vehicle 1-1 or 1-2 after providing the emergency warning signal to the driver of the vehicle 1-1 or 1-2, the electronic control unit (or controller) 100 of the vehicle 1-1 or 1-2 may transmit the predicted information indicating that the vehicle 1-1 or 1-2 is about to violate a vehicle stop signal to the nearest signal controller 2.

The nearest signal controller 2 may receive predicted information indicating that the vehicle 1 is about to violate a vehicle stop signal from the vehicle 1-1 or 1-2, and, when the signal of the crosswalk has not yet changed to a vehicle stop signal, delay the change to the vehicle stop signal for a predetermined time so as to generate the vehicle stop signal after the vehicle 1-1 or 1-2 passes the crosswalk.

According to an embodiment, when the nearest signal controller 2 receives the predicted information indicating that the vehicle 1-1 or 1-2 is about to violate the vehicle stop signal from the vehicle 1-1 or 1-2, the nearest signal controller 2 may control the audio signal device 250 to provide a warning signal to the pedestrian on the crosswalk.

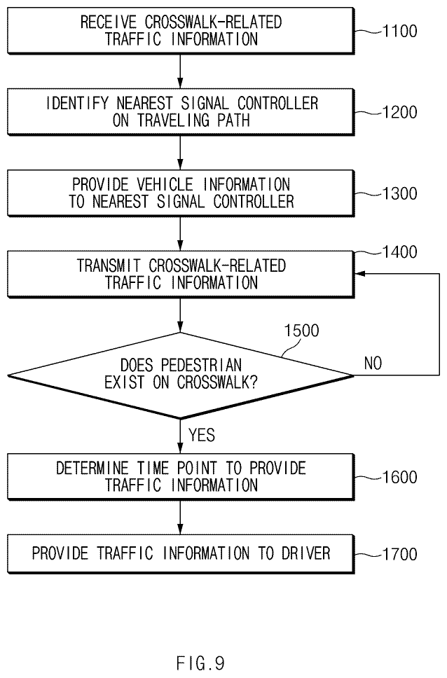

FIG. 9 is a flowchart for describing a driving assistance method according to another embodiment of the present disclosure.

Referring to FIG. 9, the driving assistance method may include receiving driving information and vehicle information from the vehicle 1 (1100), identifying a nearest signal controller on a traveling path based on navigation path information included in the driving information (1200), providing vehicle information to the identified nearest signal controller (1300), transmitting traffic information on a crosswalk to the vehicle 1 (1400), when a pedestrian is present in the crosswalk (1500), determining a time point at which to provide crosswalk-related traffic information to a driver based on driver age information (1600), and providing the traffic information to the driver at the determined time point (1700).

In the operation of receiving the driving information and vehicle information from the vehicle 1 (1100), the server 3 may receive the driving information and the vehicle information of the vehicle 1 by performing V2X communication with the vehicle 1.

In the operation of identifying the nearest signal controller on the traveling path based on the navigation path information included in the driving information, the server 3 may identify the nearest signal controller 2 on the traveling path of the vehicle 1 based on the navigation path information.

Next, the server 3 may provide the vehicle information to the identified nearest signal controller 2 (1300).

In the operation of transmitting the crosswalk-related traffic information to the vehicle 1 (1400), the nearest signal controller 2 may identify the vehicle 1 based on the vehicle information received from the server 3 and transmit the crosswalk-related traffic information to the corresponding vehicle 1.

Next, the vehicle 1 may identify whether a pedestrian is present in the crosswalk based on the crosswalk-related traffic information received from the nearest signal controller 2 (1500).

When a pedestrian is present in the crosswalk, the vehicle 1 may determine the time point at which to provide the crosswalk-related traffic information to the driver based on the driver age information (1600).

Finally, the vehicle 1 may provide the traffic information to the driver at the determined time point (1700).

The driving assistance method of FIG. 9 according to another embodiment of the present disclosure is not limited thereto, and may further include various additional operations disclosed in the present disclosure.

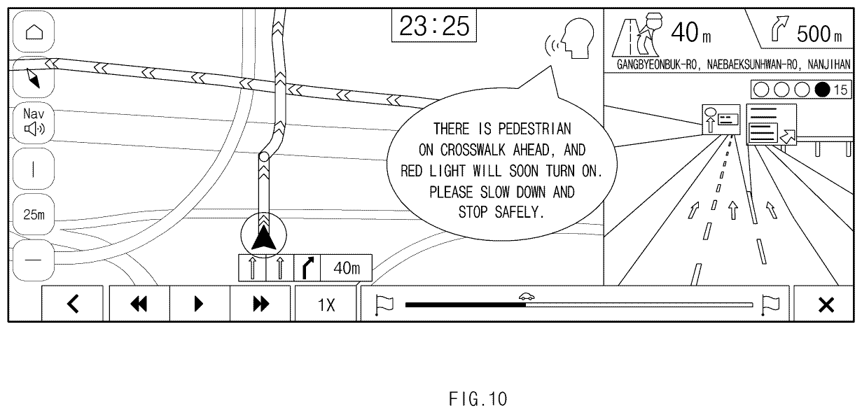

FIG. 10 is a diagram showing a screen that receives crosswalk-related traffic information according to an embodiment of the present disclosure and provides a notification to a driver through a navigation device for a vehicle.

Referring to FIG. 10, it may be seen that the vehicle 1 provides crosswalk-related traffic information as a text graphic on the display of the navigation device 10 as the vehicle 1 receives the crosswalk-related traffic information from the signal controller 2.

It may be seen from FIG. 10 that the crosswalk-related traffic information includes information indicating that a pedestrian is present in a crosswalk ahead, information indicating that a vehicle stop signal (red signal) is about to be turned on, relevant safety instructions and similar information

As described above, the stopping sight distance of the vehicle 1 is determined by considering the perception-reaction time according to the driver's age, and the time point at which to provide the crosswalk-related traffic information to the driver is determined, and the crosswalk-related traffic information is provided to the driver at the determined time point, enabling the driver to perform the braking at an appropriate time with a sufficient safety distance secured.

The above description is merely illustrative of the technical idea of the present disclosure, and various modifications and variations may be made without departing from the essential characteristics of the present disclosure by those skilled in the art to which the present disclosure pertains.

Accordingly, the embodiment disclosed in the present disclosure is not intended to limit the technical idea of the present disclosure but to describe the present disclosure, and the scope of the technical idea of the present disclosure is not limited by the embodiment. The scope of protection of the present disclosure should be interpreted by the following claims, and all technical ideas within the scope equivalent thereto should be construed as being included in the scope of the present disclosure.

The present technology may provide a driving assistance device and method capable of improving road safety by providing a driver with crosswalk-related traffic information at an appropriate time point according to the driver's age.

In addition, the present technology may provide a driving assistance device and method capable of providing the driver with crosswalk-related traffic information at a more accurate time point by considering the driver's perception-reaction time, the vehicle's driving speed, the road surface condition, and weather information.

In addition, various effects may be provided that are directly or indirectly understood through the disclosure.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A driving assistance device provided in a vehicle, the driving assistance device comprising:
a communication device configured to receive crosswalk-related traffic information by performing V2X (Vehicle to Everything) communication with a signal controller; and
a controller configured to:
identify whether a pedestrian is present in a crosswalk based on the crosswalk-related traffic information,
based on identifying that the pedestrian is present in the crosswalk, determine a time point at which to provide the crosswalk-related traffic information to a driver of the vehicle based on driving information of the vehicle and driver age information, and
provide the crosswalk-related traffic information to the driver at the determined time point.

2. The driving assistance device of claim 1, wherein the controller is configured to:
determine a perception-reaction time of the driver based on the driver age information,
determine a stopping sight distance of the vehicle based on the perception-reaction time of the driver and the driving information, and
determine the time point at which to provide the crosswalk-related traffic information to the driver based on the stopping sight distance.

3. The driving assistance device of claim 2, wherein the controller is configured to determine the stopping sight distance of the vehicle in further consideration of weather information.

4. The driving assistance device of claim 1, wherein the crosswalk-related traffic information includes presence or absence of pedestrians, vehicle signal change information, and vehicle stop signal remaining time information.

5. The driving assistance device of claim 1, wherein the controller is configured to advance the time point as the driver's age increases based on preset perception-reaction times by age group.

6. The driving assistance device of claim 1, wherein the controller is further configured to monitor the driving information of the vehicle after providing the crosswalk-related traffic information to the driver at the time point.

7. The driving assistance device of claim 6, wherein the controller is configured to predict whether the vehicle is about to violate a vehicle stop signal based on the driving information of the vehicle.

8. The driving assistance device of claim 7, wherein the controller is configured to control the communication device to perform V2P (Vehicle to Pedestrian) communication with a pedestrian terminal of the pedestrian to provide a warning signal to the pedestrian terminal based on predicting that the vehicle is about to violate the vehicle stop signal.

9. The driving assistance device of claim 7, wherein the controller is configured to provide an emergency warning signal to the driver based on predicting that the vehicle is about to violate the vehicle stop signal, or the controller is configured to perform emergency braking based on predicting that braking control of the vehicle is not performed based on the driving information after providing the emergency warning signal to the driver.

10. A vehicle comprising the driving assistance device of claim 1.

11. A driving assistance method for assisting a driver of a vehicle, the driving assistance method comprising:
receiving, by a communication device of the vehicle, crosswalk-related traffic information by performing V2X (Vehicle to Everything) communication with a signal controller;
identifying, by a controller, whether a pedestrian is present in a crosswalk based on the crosswalk-related traffic information;
determining, by the controller, based on identifying that the pedestrian is present in the crosswalk, a time point at which to provide the crosswalk-related traffic information to a driver based on driving information of a vehicle and driver age information; and
providing the crosswalk-related traffic information to the driver at the determined time point.

12. The driving assistance method of claim 11, wherein the determining of the time point includes
determining a perception-reaction time of the driver based on the driver age information;
determining a stopping sight distance of the vehicle based on the perception-reaction time of the driver and the driving information; and
determining the time point at which to provide the crosswalk-related traffic information to the driver based on the stopping sight distance.

13. The driving assistance method of claim 12, wherein the determining of the stopping sight distance includes determining the stopping sight distance of the vehicle in further consideration of weather information.

14. The driving assistance method of claim 11, wherein the crosswalk-related traffic information includes presence or absence of pedestrians, vehicle signal change information, and vehicle stop signal remaining time information.

15. The driving assistance method of claim 11, wherein the determining of the time point includes advancing the time point as the driver's age increases based on preset perception-reaction times by age group.

16. The driving assistance method of claim 11, further comprising:
monitoring the driving information of the vehicle.

17. The driving assistance method of claim 16, further comprising:
predicting whether the vehicle is about to violate a vehicle stop signal based on the driving information of the vehicle.

18. The driving assistance method of claim 17, further comprising:
performing V2P (Vehicle to Pedestrian) communication with a pedestrian terminal of the pedestrian to provide a warning signal to the pedestrian terminal based on predicting that the vehicle is about to violate the vehicle stop signal.

19. The driving assistance method of claim 17, further comprising:
providing an emergency warning signal to the driver based on predicting that the vehicle is about to violate the vehicle stop signal.

20. The driving assistance method of claim 19, further comprising:
performing emergency braking when it is identified that braking control of the vehicle is not performed based on the driving information after providing the emergency warning signal to the driver.
